(19) United States
(12) Patent Application Publication
(10) Pub. No.: US 2023/0026787 A1
(43) Pub. Date: Jan. 26, 2023

(54) LEARNING FEATURE IMPORTANCE FOR IMPROVED VISUAL EXPLANATION

(71) Applicant: The Boeing Company, Chicago, IL (US)

(72) Inventors: Kwang Hee Lee, Seoul (KR); Chaewon Park, Seoul (KR); Junghyun Oh, Seoul (KR)

(73) Assignee: The Boeing Company, Chicago, IL (US)

(21) Appl. No.: 17/664,447

(22) Filed: May 23, 2022

Related U.S. Application Data
(60) Provisional application No. 63/223,811, filed on Jul. 20, 2021.

(51) Int. Cl. G06N 3/04; G06V 10/80; G06V 10/82

(52) U.S. Cl. CPC G06N 3/0454; G06V 10/80; G06V 10/82

(57) ABSTRACT

Systems, methods and computer readable media provide technology to perform image classification and produce visualization using a machine learning architecture. The disclosed image classification and visualization technology includes a feature extraction network to generate a feature map, a feature importance network to generate a feature importance vector, an attention map generated based on a weighted sum of the feature importance vector and the feature map, a classification output determined based on a combination of the attention map and the feature map, and a feature visualization image generated by overlaying the attention map onto an input image. Each of the feature extraction network and the feature importance network can include a neural network.

### CROSS REFERENCE TO RELATED APPLICATIONS

This application claims benefit of and priority to U.S. Provisional Patent Application No. 63/223,811, filed Jul. 20, 2021, the contents of which are incorporated herein by reference in its entirety.

### FIELD

The disclosure relates to technology for image classification. More particularly, the disclosure relates to an improved machine learning architecture for image classification and visual explanation.

### BACKGROUND

Machine learning technology, such as deep neural network models using convolutional neural networks, has become increasingly utilized in the field of computer vision and image classification. Most deep neural network models are considered to be “black box” solutions because of the large number of parameters, implicit nonlinearities, and the lack of visibility into the inner layers of the models. The resulting difficulty in interpreting or explaining classification decisions has led to a desire for interpretation aids, such as visualization techniques. Prior visualization solutions, however, have a number of limitations, such as, for example, unstable and suboptimal visual mappings, slow performance, loss of classification accuracy, need for retraining, etc.

Accordingly, there is a need for an improved image classification system with reliable visualization for highlighting model interpretations.

### SUMMARY

In accordance with one or more examples, a computing system comprises a processor, and a memory coupled to the processor, the memory storing instructions which, when executed by the processor, cause the computing system to perform operations comprising generating, via a feature extraction network, based on an input image, one or more of a first feature map or a second feature map, generating, via a feature importance network, a feature importance vector based on combining the input image and the first feature map, generating an attention map based on a weighted sum of the feature importance vector and the first feature map, determining a classification output based on combining the attention map and one or more of the first feature map or the second feature map, and generating a feature visualization image by overlaying the attention map onto the input image.

In accordance with one or more examples, a method comprises generating, via a feature extraction network, based on an input image, one or more of a first feature map or a second feature map, generating, via a feature importance network, a feature importance vector based on combining the input image and the first feature map, generating an attention map based on a weighted sum of the feature importance vector and the first feature map, determining a classification output based on combining the attention map and one or more of the first feature map or the second feature map, and generating a feature visualization image by overlaying the attention map onto the input image.

In accordance with one or more examples, at least one non-transitory computer readable medium comprises instructions which, when executed by a computing system, cause the computing system to perform operations comprising generating, via a feature extraction network, based on an input image, one or more of a first feature map or a second feature map, generating, via a feature importance network, a feature importance vector based on combining the input image and the first feature map, generating an attention map based on a weighted sum of the feature importance vector and the first feature map, determining a classification output based on combining the attention map and one or more of the first feature map or the second feature map, and generating a feature visualization image by overlaying the attention map onto the input image.

The features, functions, and advantages that have been discussed can be achieved independently in various examples or can be combined in yet other examples, further details of which can be seen with reference to the following description and drawings.

### BRIEF DESCRIPTION OF THE DRAWINGS

The various advantages of the examples of the present disclosure will become apparent to one skilled in the art by reading the following specification and appended claims, and by referencing the following drawings, in which:

FIG. 1 provides a block diagram illustrating an overview of an image classification and visualization system according to one or more examples;

FIG. 2 provides a block diagram illustrating an image classification and visualization system according to one or more examples;

FIG. 3 provides a block diagram illustrating a perception module for use in an image classification and visualization system according to one or more examples;

FIG. 4 provides a block diagram illustrating an attention module for use in an image classification and visualization system according to one or more examples;

FIGS. 5A-5D provide flow diagrams illustrating methods for image classification and visualization according to one or more examples;

FIGS. 6A-6B provide illustrations of example input images and feature visualization images in an image classification and visualization system according to one or more examples; and

FIG. 7 is a diagram illustrating a computing system for use in an image classification and visualization system according to one or more examples.

Accordingly, it is to be understood that the examples herein described are merely illustrative of the application of the principles disclosed. Reference herein to details of the illustrated examples is not intended to limit the scope of the claims, which themselves recite those features regarded as essential to the disclosure.

### DESCRIPTION

Disclosed herein are systems, methods and computer readable media to perform image classification and provide visualization using a machine learning architecture. The system includes a perception module to generate a feature map, and an attention module to learn the importance of features and generate an attention map. The attention map is combined with the feature map by the perception module to provide a classification output. The attention map is used to overlay the input image to provide a visualization result that highlights the most important features identified by the system. As disclosed herein, the image classification and visualization technology provides advantages including improved classification results and stable visualization mappings without the need for retraining. For example, the disclosed attention module generates an attention map for visual explanation by learning feature importance from a feature map and the input image, while the disclosed perception module leverages the attention map to improve the classification performance through an attention mechanism.

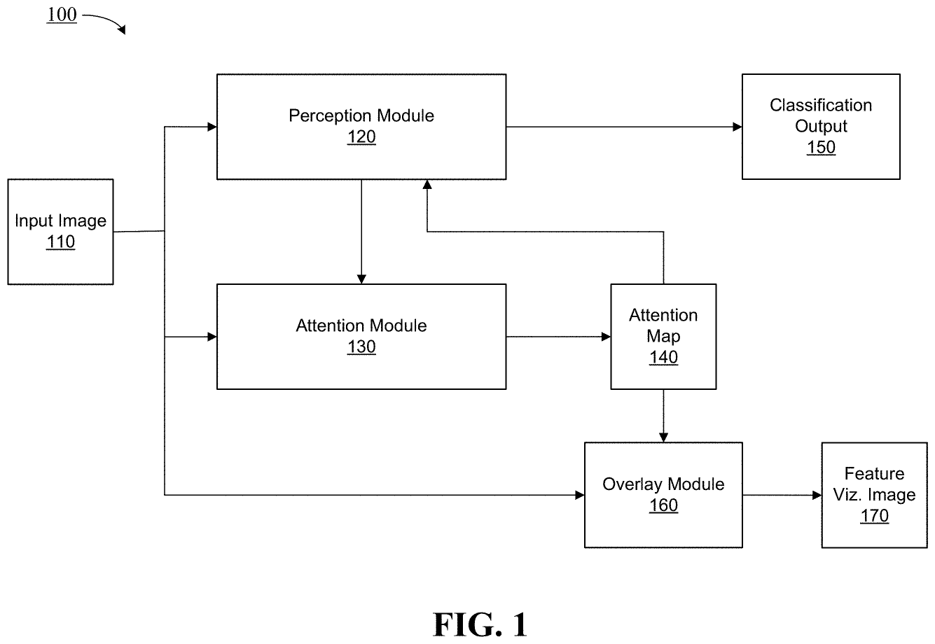

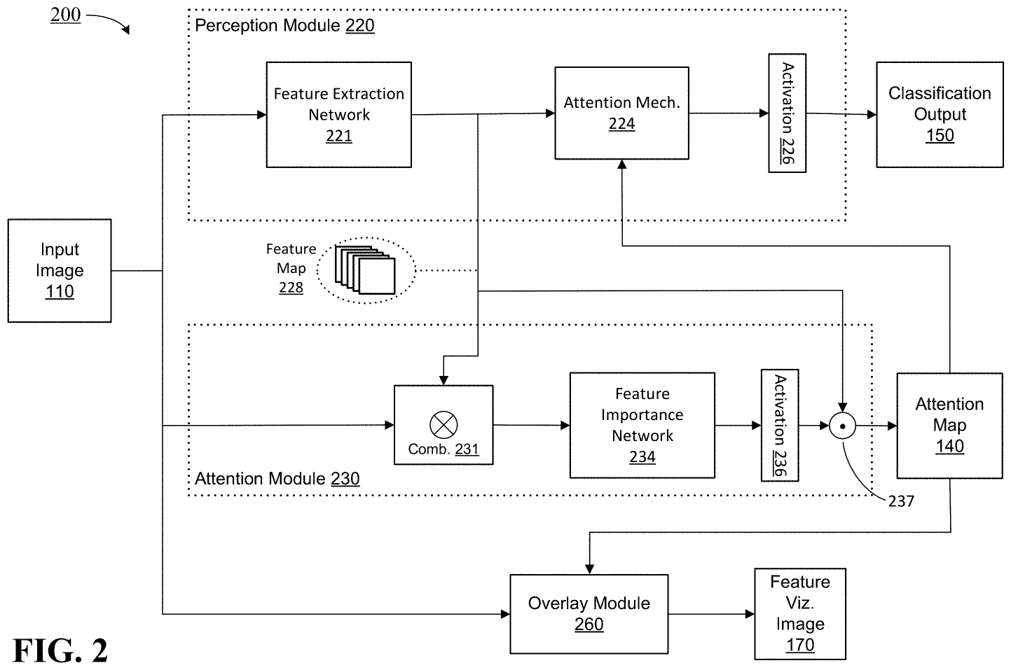

FIG. 1 is a block diagram illustrating an overview of a system 100 to perform image classification and visualization according to one or more examples, with reference to components and features described herein including but not limited to the figures and associated description. The system 100 receives an input image 110 for processing. In some examples, a plurality of input images can be provided from an image sequence (e.g., from a video). The input image 110 is provided as input to the components of system 100, which include a perception module 120, an attention module 130, and an overlay module 160. The perception module 120 is configured to generate a feature map (not shown in FIG. 1) that includes features obtained from the input image 110. The attention module 130 is configured to learn the importance of features in the input image and feature map and generate an attention map 140. The attention map 140 provides a map reflecting the learned relative importance of features derived from the input image, and is combined with the feature map by the perception module 120 to provide a classification output 150. The overlay module 160 receives the attention map 140 and overlays the input image 110 with the attention map 140 to output the image with overlay as a feature visualization image 170. The feature visualization image 170 highlights the most important features identified by the system in generating classification results. Further details of the system 100, its components and operation are described herein with reference to FIGS. 2-7.

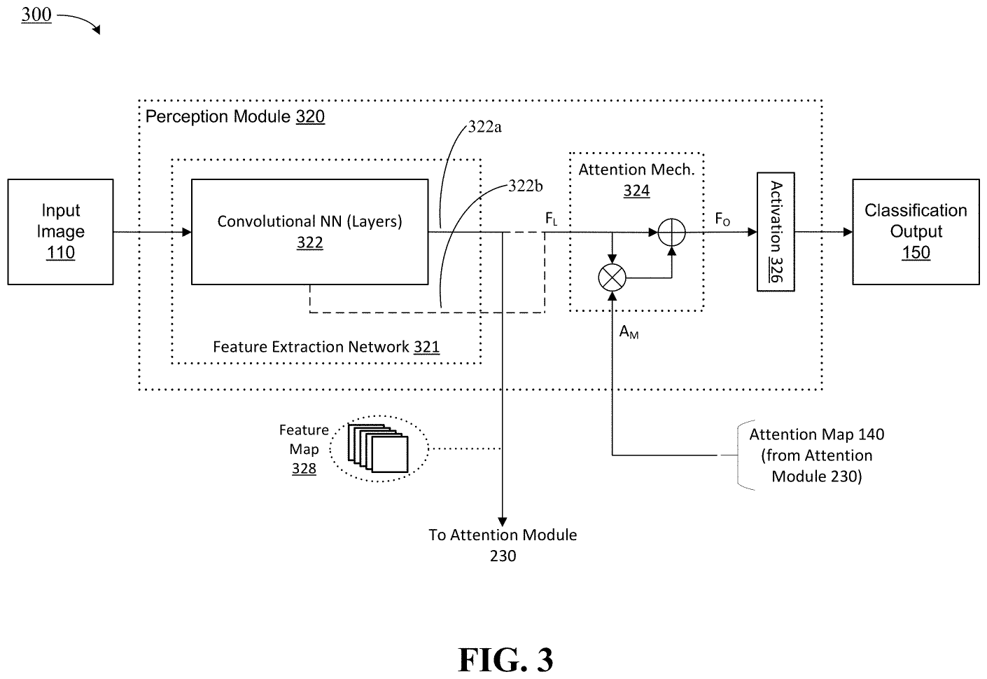

FIG. 2 provides a block diagram illustrating details of components of a system 200 to perform image classification and visualization according to one or more examples, with reference to components and features described herein including but not limited to the figures and associated description. As shown in FIG. 2, the system 200 includes a perception module 220, an attention module 230, and an overlay module 260. The system 200 corresponds to the system 100 (FIG. 1, already discussed). The perception module 220 includes a feature extraction network 221, an attention mechanism 224, and an activation function 226. The perception module 220 corresponds to the perception module 120 (FIG. 1, already discussed). The feature extraction network 221 processes the input image 110 and generates a feature map 228, which includes features derived from the input image 110. The feature map 228 (or, alternatively, a second feature map, not shown in FIG. 2) is provided to the attention mechanism 224, as further described herein. The feature map 228 is also provided to components of the attention module 230, as further described herein. The attention mechanism 224 combines the feature map 228 (or, alternatively, the second feature map) with the attention map 140 to produce an output map. The output map is processed through the activation function 226 to produce the classification output 150. In embodiments, the Softmax function is selected as the activation function 226; other activation functions can be substituted for the Softmax function as the activation function 226. Additional details for the perception module 220 are described herein with reference to FIG. 3.

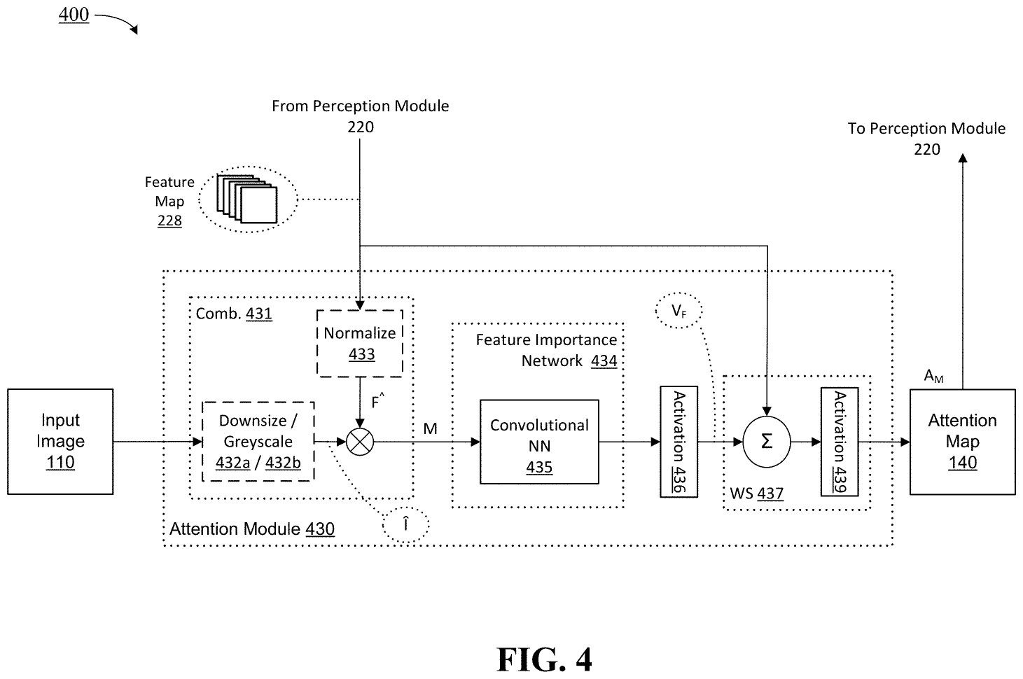

The attention module 230 includes a combination unit 231, a feature importance network 234, an activation function 236 and a weighted sum unit 237. The attention module 230 corresponds to the attention module 130 (FIG. 1, already discussed). The combination unit 231 combines the input image 110 with the feature map 228, and the combination results are provided to the feature importance network 234. The feature importance network 234 processes the combination results from the combination unit 231 and learns the importance of features in the input image and the feature map. The activation function 236 is applied to the results of the processing by the feature importance network 234 to produce a feature importance vector. The feature importance vector is combined with the feature map 228 in the weighted sum unit 237 to generate the attention map 140. As mentioned above, the attention map 140 provides a map reflecting the relative importance of features derived from the input image, where the relative importance of features is learned by the feature importance network 234. In embodiments, the Softmax function is selected as the activation function 236; other activation functions can be substituted for the Softmax function as the activation function 236. Additional details for the attention module 230 are described herein with reference to FIG. 4.

The overlay module 260 receives as input the input image 110 and the attention map 140, and combines them by overlaying the attention map 140 over the input image 110 to generate the feature visualization image 170. In one or more examples, the processing by overlay module 260 includes adjusting the respective sizes of and/or re-scaling the input image 110 and/or the attention map 140 to produce a feature visualization image 170 suitable for showing which features are most important. In examples, the input image 110 and attention map 140 are blended together with a ratio of 1:1 (i.e., a contribution of 50% for each of the input image 110 and attention map 140); other ratios can be applied. The feature visualization image 170 provides a visualization of the importance of features derived from the input image 110 (by the system 200) for purposes of classification. The overlay module 260 corresponds to the overlay module 160 (FIG. 1, already discussed).

FIG. 3 is a block diagram 300 illustrating a perception module 320 for use in an image classification and visualization system according to one or more examples, with reference to components and features described herein including but not limited to the figures and associated description. As shown in FIG. 3, the perception module 320 includes a feature extraction network 321, an attention mechanism 324, and an activation function 326. The perception module 320 corresponds to the perception module 120 (FIG. 1, already discussed) and to the perception module 220 (FIG. 2, already discussed). Each of the feature extraction network 321, the attention mechanism 324, and the activation function 326 corresponds, respectively, to the feature extraction network 221, the attention mechanism 224, and the activation function 226 (FIG. 2, already discussed). When operating in inference mode, the perception module 320 generates a multi-channel feature map by passing the input through multiple convolutional layers (via the neural network 322), and predicts a classification output through combining the feature map and the attention map 140 (from the attention module 230) via the attention mechanism 324. Each channel of the multi-channel feature map corresponds to each filter channel in the perception module (e.g., each filter channel or layer in a neural network of the perception module), and learns a set of weights. Because there are multiple filters in the perception module, each filter learns a different set of weights that represents a different feature or characteristic of the input image.

The feature extraction network 321 includes a neural network 322 such as a convolutional neural network (CNN) having a plurality of layers. The neural network 322 can employ machine learning (ML) and/or deep neural network (DNN) techniques. In one or more examples, the neural network 322 can include other types of neural networks. As an example, for image sequences (e.g., video) the neural network 322 can include a recurrent neural network (RNN). In one or more examples, the neural network 322 can include a residual block (not shown in FIG. 3).

Upon processing the input image 110, the neural network 322 generates a feature map 328. The feature map 328 as provided to the attention module 230 is a first feature map 322a obtained from the last convolutional layer of the neural network 322. In some examples, the feature map F_{L} provided to the attention mechanism 324 is also the first feature map 322a obtained from the last convolutional layer of the neural network 322. In one or more examples, the feature map F_{L} provided to the attention mechanism 324 is a second feature map 322b obtained from an intermediate convolutional layer, which is a layer (e.g., an internal layer), other than the last convolutional layer, of the neural network 322. In one or more examples, the feature map F_{L} provided to attention mechanism 324 is obtained from a combination of convolutional layers of the neural network 322, such as the last convolutional layer and/or the intermediate convolutional layer. A combination of convolutional layers can include a weighted sum of the convolutional layers. The last convolutional layer typically provides higher-level features, while the intermediate convolutional layer typically provides lower-level features. The feature map 328 as well as the feature map F_{L} is generally a three-dimensional matrix, where two dimensions represent the height and width (h×w) of the respective map and where the third dimension represents the number of channels in the respective map. The number of channels in the respective map is the same as the number of channels of the convolution layer from which the respective map is obtained.

The attention mechanism 324 operates to combine the feature map F_{L} and the attention map 140 (e.g., attention map 140 in FIG. 2, already discussed). As shown in FIG. 3, the attention mechanism 324 performs a mathematical operation, as follows:

F_{O}=F_{L}⊗(1+A_{M}) EQ. (1)

where F_{O} is the output map generated as an output of the attention mechanism 324, F_{L} is the first or second feature map from the neural network 322, A_{M} is the attention map 140, and ⊗ denotes an element-wise multiplication function. In some examples, the attention map A_{M} is normalized to the range {0, 1} before being input to the attention mechanism 324. In some examples, the attention mechanism 324 can combine the feature map 328 and the attention map using other operations.

To determine the classification output 150, the activation function 326 is applied to the output map F_{O} generated by the attention mechanism 324. The activation function 326 produces a vector output. In embodiments, the Softmax function is selected as the activation function 326 because, in image classification operations, the Softmax function vector output represents the respective probabilities (which all sum up to 1) that the input is in one of the respective classes. For example, if the classification operation is used for classifying a type of animal in an image, and if the universe of animal types (for which the classifier is trained) is a list of four animals, such as {dog; cat; duck; bear}, then the classification output, as provided by the vector output of the Softmax function, would represent the respective probabilities that the subject image contained a dog, cat, duck or bear. In an example, if the vector output of the Softmax function is {0.1, 0.1, 0.7, 0.1}, this would represent as a classification output the probabilities that the subject image is a dog: 10%, cat: 10%, duck: 70%, and bear: 10%. Other activation functions that serve to provide respective probabilities can be substituted for the Softmax function as the activation function 326.

FIG. 4 is a block diagram 400 illustrating an attention module 430 for use in an image classification and visualization system according to one or more examples, with reference to components and features described herein including but not limited to the figures and associated description. As shown in FIG. 4, the attention module 430 includes a combination unit 431, a feature importance network 434, an activation function 436, and a weighted sum unit 437. The attention module 430 corresponds to the attention module 130 (FIG. 1, already discussed) and to the attention module 230 (FIG. 2, already discussed). Each of the combination unit 431, the feature importance network 434, the activation function 436 and the weighted sum unit 437 corresponds, respectively, to the combination unit 231, the feature importance network 234, the activation function 236 and the weighted sum unit 237 (FIG. 2, already discussed). When operating in inference mode, the attention module 430 learns the feature importance of each channel of the feature map 228 (from the perception module 220), and then generates the attention map 140 by calculating a weighted sum of the feature map and learned feature importance.

The combination unit 431 combines the input image 110 with the feature map 228 through a multiplication function, and the combination results in a masked image M that is provided to the feature importance network 434. In some examples, the input image 110 is processed through a downsize/greyscale function 432a 432b (shown in dotted lines). The downsize function 432a reduces the size of the image; when the image is a color image, the greyscale function 432b converts color to greyscale:

Î=D_{S}(G_{S}(I)) EQ. (2)

where Î is the resulting image, D_{S} ( ) is a downsize function, and G_{S}( ) is a color-to-greyscale conversion function. The downsize function reduces the size of the image to the two-dimensional size (h×w) of the feature map 228 (ignoring the depth of the feature map 228). In some examples, the feature map 228 is processed through a normalize function 433 that maps each element of the feature map(s) to the range {0, 1}; the resulting normalized feature map is denoted F\hat{ }. The multiplication function of the combination unit 431 provides a masked image M as follows:

M=Î⊗F\hat{ } EQ. (3)

where Î is the resulting image (from EQ. 2), F\hat{ } is the normalized feature map, and ⊗ denotes an element-wise multiplication function. The masked image M is a concatenated multi-layer set of images {M₁, M₂, M_{N}} with the number of layers (N) equal to the number of channels (N) in the normalized feature map F\hat{ }. The masked image M is provided as input for processing by the feature importance network 434.

The feature importance network 434 includes a neural network 435 such as a convolutional neural network (CNN) having a plurality of layers. The neural network 435 can employ machine learning (ML) and/or deep neural network (DNN) techniques. In some examples, the neural network 435 is a 3-layer CNN. In one or more examples, the neural network 435 can include other types of neural networks, such as, e.g., a recurrent neural network (RNN) or a multilayer perceptron.

When operating in inference mode, the neural network 435 operates on the masked image M, and the activation function 436 is applied to the output of the neural network 435 to generate a feature importance vector V_{F}. The feature importance vector V_{F} is a 1× N vector (where N is the number of channels) which includes a set of weights wₖ, each weight wₖ representing a feature importance score for the k-th channel of the feature map. In one or more examples, a batch normalization process (not shown in FIG. 4) can be performed on the output of the neural network 435 before applying the activation function 436. In embodiments, the Softmax function is selected as the activation function 436; other activation functions can be substituted for the Softmax function as the activation function 436.

The feature importance vector V_{F} is then combined with the feature map 228 in the weighted sum unit 437. The weighted sum unit 437 applies a weighted sum function to generate the attention map 140 (A_{M}) via an activation function 439 as follows:

A_{M}=ReLU(Σₖ₌₁^{N}wₖF_{M}^{k}) EQ. (4)

where A_{M} is the generated attention map 140, wₖ is the k-th weight of the feature importance vector V_{F}, F_{M}^{k} is the k-th channel of the feature map 228, and ReLU( ) is the rectified linear unit function. The attention map 140 is provided to the perception module 220 and to the overlay module 260 as described above. In embodiments, the rectified linear unit function (ReLU) is selected as the activation function 439 applied to the output of the weighted sum unit 437. The ReLU function is used as the activation function 439 to remove features with negative influence. Other activation functions that serve to remove features with negative influence can be substituted for the rectified linear unit function as the activation function 439.

Each of the system 100 and the system 200 is trained with a set of input training images containing examples of the types of objects for which classification is desired. In some examples, the system is trained end-to-end. In the end-to-end training scenario, the neural network in each of the perception module (e.g., the neural network 322) and the neural network in the attention module (e.g., the neural network 435) are trained at the same time. The system is trained in an end-to-end manner using training loss calculated as the combination of the Softmax function and cross-entropy at the perception module in an image classification task. The attention module is optimized by the attention mechanism of the perception branch to improve the classification accuracy without any additional loss function. In some examples, the neural network 322 and the neural network 435 are trained separately. In this scenario, the neural network 322 is trained first, and then the neural network 435 is trained. In one or more examples, the neural network 322 is a pre-trained neural network model, and the neural network 435 is trained using the pre-trained neural network model as the neural network 322.

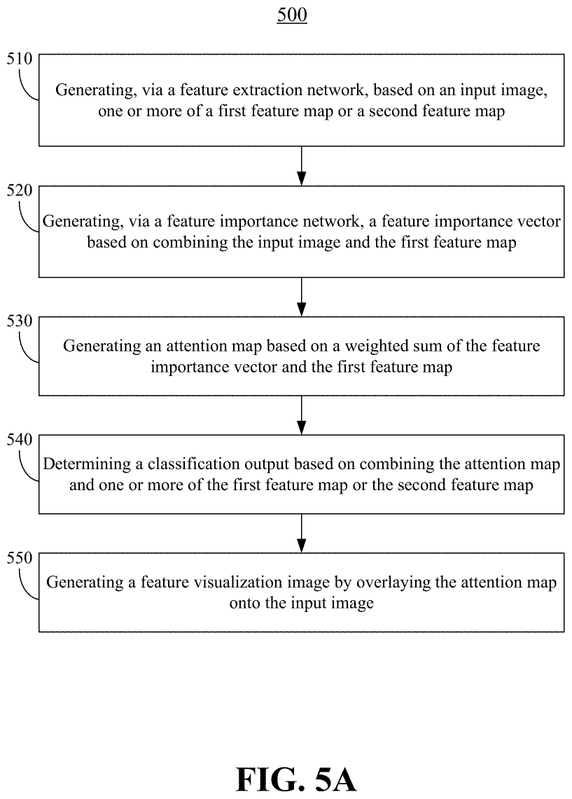

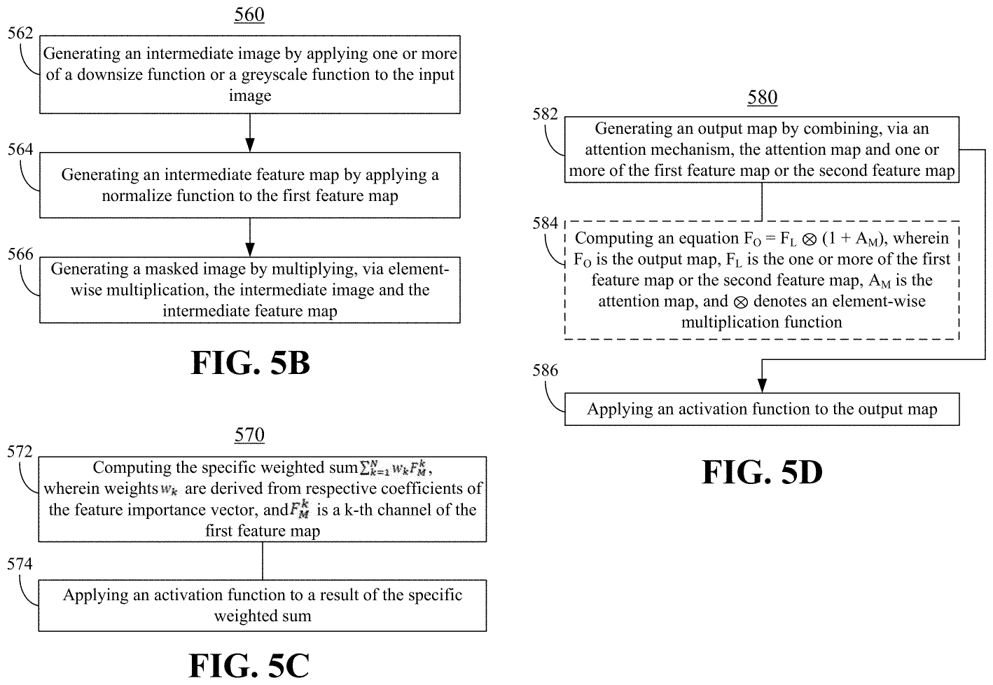

FIG. 5A is a flow diagram illustrating a method 500 of image classification and visualization according to one or more examples, with reference to components and features described herein including but not limited to the figures and associated description. In one or more examples, the method 500 is implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

The method 500 begins at illustrated processing block 510 by generating, via a feature extraction network, based on an input image, one or more of a first feature map or a second feature map. In examples, the feature extraction network corresponds to the feature extraction network 221 (FIG. 2, already discussed) and/or to the feature extraction network 321 (FIG. 3, already discussed). In examples, the feature extraction network comprises a first neural network including a plurality of convolution layers. In examples, the first feature map is obtained from a last layer of the plurality of convolution layers. In examples, the second feature map is obtained from an intermediate layer, other than the last layer, of the plurality of convolution layers.

Illustrated processing block 520 provides for generating, via a feature importance network, a feature importance vector based on combining the input image and the first feature map. In examples, the feature importance network corresponds to the feature importance network 234 (FIG. 2, already discussed) and/or to the feature importance network 434 (FIG. 4, already discussed). In examples, the feature importance network comprises a second neural network.

Illustrated processing block 530 provides for generating an attention map based on a weighted sum of the feature importance vector and the first feature map. Illustrated processing block 540 provides for determining a classification output based on combining the attention map and one or more of the first feature map or the second feature map. Illustrated processing block 550 provides for generating a feature visualization image by overlaying the attention map onto the input image.

FIG. 5B is a flow diagram illustrating a method 560 of combining the input image and the first feature map according to one or more examples, with reference to components and features described herein including but not limited to the figures and associated description. In examples, the method 560 can be substituted for at least a portion of illustrated processing block 520 (FIG. 5A, already discussed). In one or more examples, the method 560 is implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

The method 560 includes illustrated processing block 562, which provides for generating an intermediate image by applying one or more of a downsize function or a greyscale function to the input image. Illustrated processing block 564 provides for generating an intermediate feature map by applying a normalize function to the first feature map. Illustrated processing block 566 provides for generating a masked image by multiplying, via element-wise multiplication, the intermediate image and the intermediate feature map.

FIG. 5C is a flow diagram illustrating a method 570 of generating an attention map based on a weighted sum of the feature importance vector and the first feature map according to one or more examples, with reference to components and features described herein including but not limited to the figures and associated description. In examples, the method 570 can be substituted for at least a portion of illustrated processing block 530 (FIG. 5A, already discussed). In one or more examples, the method 570 is implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

The method 570 includes, at illustrated processing block 572, computing the specific weighted sum Σₖ₌₁^{N}wₖF_{M}^{k}, wherein weights wₖ are derived from respective coefficients of the feature importance vector, and F_{M}^{k} is a k-th channel of the first feature map. Illustrated processing block 574 provides for applying an activation function to a result of the specific weighted sum. In some embodiments, the rectified linear unit function (ReLU) is used as the activation function.

FIG. 5D is a flow diagram illustrating a method 580 of combining the attention map and one or more of the first feature map or the second feature map according to one or more examples, with reference to components and features described herein including but not limited to the figures and associated description. In examples, the method 580 can be substituted for at least a portion of illustrated processing block 540 (FIG. 5A, already discussed). In one or more examples, the method 580 is implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

The method 580 includes, at illustrated processing block 582, generating an output map by combining, via an attention mechanism, the attention map and one or more of the first feature map or the second feature map. More particularly, in examples the attention mechanism at processing block 584 includes computing an equation F_{O}=F_{L} ⊗(1+A_{M}), wherein F_{O} is the output map, F_{L} is the one or more of the first feature map or the second feature map, A_{M} is the attention map, and ⊗ denotes an element-wise multiplication function. The method 580 then continues at illustrated processing block 586 which provides for applying an activation function to the output map. In some embodiments, the Softmax function is used as the activation function.

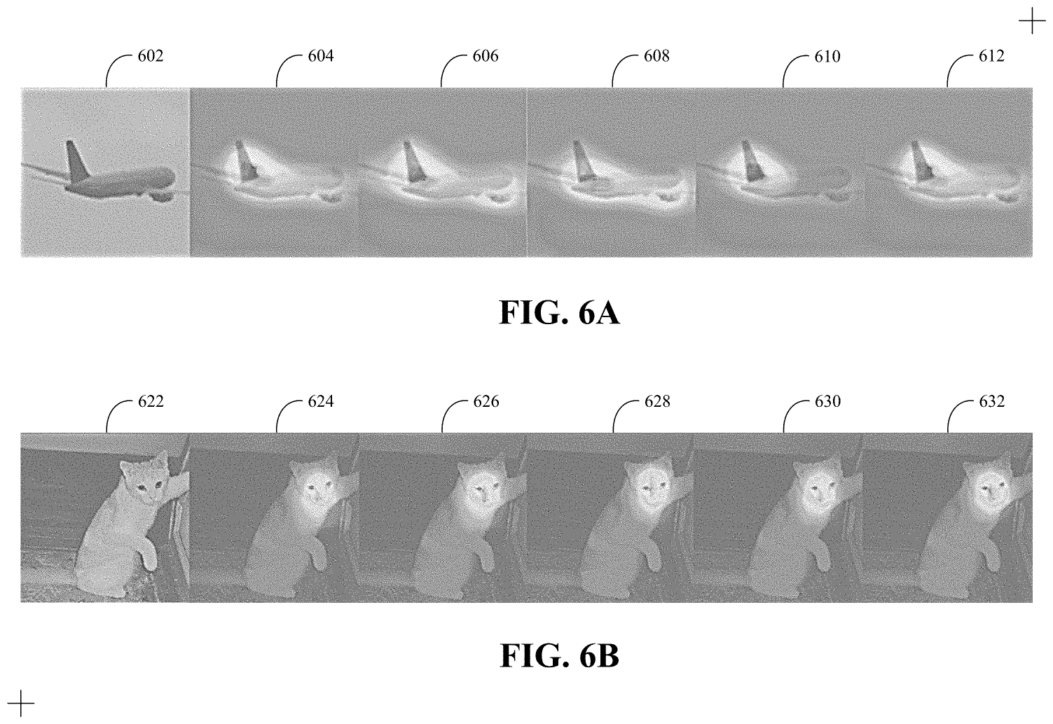

FIGS. 6A-6B provide illustrations of example input images and feature visualization images (converted from color to greyscale) in an image classification and visualization system according to one or more examples, with reference to components and features described herein including but not limited to the figures and associated description. In FIG. 6A, an example input image of a plane is shown at label 602. At labels 604, 606, 608, 610, and 612 are example feature visualization images produced, based on the example input image 602, by an example of the image classification and visualization system as described herein. Each of the example feature visualization images 604-612 were produced by training the system with a respective different parameter set. In each of the example feature visualization images 604-612, the white areas show the features identified by the system as the most important features in determining classification. Shown in FIG. 6B is an example input image of a cat at label 622. In FIG. 6B, at labels 624, 626, 628, 630, and 632 are example feature visualization images produced, based on the example input image 622, by an example of the image classification and visualization system as described herein. In each of the example feature visualization images 624-632, the white areas show the features identified by the system as the most important features in determining classification. Each of the example feature visualization images 624-632 were produced by training the system with a respective different parameter set. The example feature visualization images shown in FIG. 6A (604-612) and FIG. 6B (624-632) demonstrate the robustness and stability of the system across a variety of training parameters.

The image classification and visualization system as described herein can be used in a variety of image classification applications, including applications involving the aircraft industry. In one example aircraft application, the image classification and visualization system can be used to review images of an aircraft or its components and make determinations of a state of the aircraft or the components—such as, e.g., whether a defect (e.g., surface defect such as scratch, bubble, dent, etc.) is present. As another example aircraft application, the image classification and visualization system can be used to review images of aircraft and make determinations of an identification of the aircraft or its components—such as, e.g., whether the aircraft is a Boeing 737, a Boeing 747, a Boeing 757, etc. As another example aircraft application, the image classification and visualization system can be used to review images of the ground or airspace surrounding an aircraft and make determinations for autonomous piloting or to assist piloting of the aircraft—such as, e.g., identification of nearby objects, landing strips, etc. The foregoing examples are described for illustrative purposes only, and the disclosed technology is not limited in application to the examples described herein.

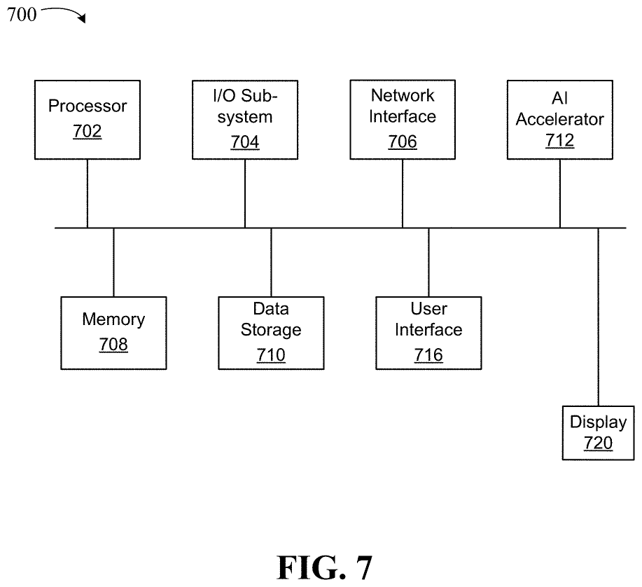

FIG. 7 is a diagram illustrating a computing system 700 for use in the system 100 and/or in the system 200 according to one or more examples, with reference to components and features described herein including but not limited to the figures and associated description. Although FIG. 7 illustrates certain components, the computing system 700 can include additional or multiple components connected in various ways. It is understood that not all examples will necessarily include every component shown in FIG. 7. As illustrated in FIG. 7, the computing system 700 includes one or more processors 702, an I/O subsystem 704, a network interface 706, a memory 708, a data storage 710, an artificial intelligence (AI) accelerator 712, a user interface 716, and/or a display 720. In some examples, the computing system 700 interfaces with a separate display. The computing system 700 can implement one or more components or features of the system 100, the system 200, and/or any of the components or methods described herein with reference to FIGS. 1, 2, 3, 4, and/or 5A-5D.

The processor 702 can include one or more processing devices such as a microprocessor, a central processing unit (CPU), a fixed application-specific integrated circuit (ASIC) processor, a reduced instruction set computing (RISC) processor, a complex instruction set computing (CISC) processor, a field-programmable gate array (FPGA), etc., along with associated circuitry, logic, and/or interfaces. The processor 702 can include, or be connected to, a memory (such as, e.g., the memory 708) storing executable instructions and/or data, as necessary or appropriate. The processor 702 can execute such instructions to implement, control, operate or interface with any components or features of the system 100, the system 200, and/or any of the components or methods described herein with reference to FIGS. 1, 2, 3, 4, and/or 5A-5D. The processor 702 can communicate, send, or receive messages, requests, notifications, data, etc. to/from other devices. The processor 702 can be embodied as any type of processor capable of performing the functions described herein. For example, the processor 702 can be embodied as a single or multi-core processor(s), a digital signal processor, a microcontroller, or other processor or processing/controlling circuit.

The I/O subsystem 704 includes circuitry and/or components suitable to facilitate input/output operations with the processor 702, the memory 708, and other components of the computing system 700.

The network interface 706 includes suitable logic, circuitry, and/or interfaces that transmits and receives data over one or more communication networks using one or more communication network protocols. The network interface 706 can operate under the control of the processor 702, and can transmit/receive various requests and messages to/from one or more other devices. The network interface 706 can include wired or wireless data communication capability; these capabilities support data communication with a wired or wireless communication network. The network interface 706 can support communication via a short-range wireless communication field, such as Bluetooth, NFC, or RFID. Examples of network interface 706 include, but are not limited to, one or more of an antenna, a radio frequency transceiver, a wireless transceiver, a Bluetooth transceiver, an ethernet port, a universal serial bus (USB) port, or any other device configured to transmit and receive data.

The memory 708 includes suitable logic, circuitry, and/or interfaces to store executable instructions and/or data, as necessary or appropriate, when executed, to implement, control, operate or interface with any components or features of the system 100, the system 200, and/or any of the components or methods described herein with reference to FIGS. 1, 2, 3, 4, and/or 5A-5D. The memory 708 can be embodied as any type of volatile or non-volatile memory or data storage capable of performing the functions described herein, and can include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, the memory 708 can store various data and software used during operation of the computing system 700 such as operating systems, applications, programs, libraries, and drivers. Thus, the memory 708 can include at least one non-transitory computer readable medium comprising instructions which, when executed by the computing system 700, cause the computing system 700 to perform operations to carry out one or more functions or features of the system 100, the system 200, and/or any of the components or methods described herein with reference to FIGS. 1, 2, 3, 4, and/or 5A-5D. The memory 708 can be communicatively coupled to the processor 702 directly or via the I/O subsystem 704.

The data storage 710 can include any type of device or devices configured for short-term or long-term storage of data such as, for example, memory devices and circuits, memory cards, hard disk drives, solid-state drives, non-volatile flash memory, or other data storage devices. The data storage 710 can include or be configured as a database, such as a relational or non-relational database, or a combination of more than one database. In some examples, a database or other data storage can be physically separate and/or remote from the computing system 700, and/or can be located in another computing device, a database server, on a cloud-based platform, or in any storage device that is in data communication with the computing system 700.

The artificial intelligence (AI) accelerator 712 includes suitable logic, circuitry, and/or interfaces to accelerate artificial intelligence applications, such as, e.g., artificial neural networks, machine vision and machine learning applications, including through parallel processing techniques. In one or more examples, the AI accelerator 712 can include a graphics processing unit (GPU). The AI accelerator 712 can implement one or more components or features of the system 100, the system 200, and/or components or methods described herein with reference to FIGS. 1, 2, 3, 4, and/or 5A-5D, including one or more of the neural network 322 (FIG. 3) and/or the neural network 435 (FIG. 4). In some examples the computing system 700 includes a second AI accelerator (not shown).

The user interface 716 includes code to present, on a display, information or screens for a user and to receive input (including commands) from a user via an input device. The display 720 can be any type of device for presenting visual information, such as a computer monitor, a flat panel display, or a mobile device screen, and can include a liquid crystal display (LCD), a light-emitting diode (LED) display, a plasma panel, or a cathode ray tube display, etc. The display 720 can include a display interface for communicating with the display. In some examples, the display 720 can include a display interface for communicating with a display external to the computing system 700.

In some examples, one or more of the illustrative components of the computing system 700 can be incorporated (in whole or in part) within, or otherwise form a portion of, another component. For example, the memory 708, or portions thereof, can be incorporated within the processor 702. As another example, the user interface 716 can be incorporated within the processor 702 and/or code in the memory 708. In some examples, the computing system 700 can be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device. In some examples, the computing system 700, or portion thereof, is implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

### Additional Notes and Examples

Further, the disclosure comprises additional examples as detailed in the following clauses.

Clause 1: A computing system comprising a processor, and a memory coupled to the processor, the memory storing instructions which, when executed by the processor, cause the computing system to perform operations comprising generating, via a feature extraction network, based on an input image, one or more of a first feature map or a second feature map, generating, via a feature importance network, a feature importance vector based on combining the input image and the first feature map, generating an attention map based on a weighted sum of the feature importance vector and the first feature map, determining a classification output based on combining the attention map and one or more of the first feature map or the second feature map, and generating a feature visualization image by overlaying the attention map onto the input image.

Clause 2: The computing system of clause 1, wherein the feature extraction network comprises a first neural network including a plurality of convolution layers, wherein the first feature map is obtained from a last layer of the plurality of convolution layers, and wherein the feature importance network comprises a second neural network.

Clause 3: The computing system of clause 1 or 2, wherein the second feature map is obtained from an intermediate layer, other than the last layer, of the plurality of convolution layers.

Clause 4: The computing system of clause 1, 2 or 3, wherein combining the input image and the first feature map comprises generating an intermediate image by applying one or more of a downsize function or a greyscale function to the input image, generating an intermediate feature map by applying a normalize function to the first feature map, and generating a masked image by multiplying, via element-wise multiplication, the intermediate image and the intermediate feature map.

Clause 5: The computing system of any of clauses 1-4, wherein generating an attention map based on a weighted sum of the feature importance vector and the first feature map comprises computing a specific weighted sum Σₖ₌₁^{N} wₖF_{M}^{k}, wherein weights wₖ are derived from respective coefficients of the feature importance vector, and F_{M}^{k} is a k-th channel of the first feature map, and applying an activation function to a result of the specific weighted sum.

Clause 6: The computing system of any of clauses 1-5, wherein combining the attention map and one or more of the first feature map or the second feature map comprises generating an output map by combining, via an attention mechanism, the attention map and one or more of the first feature map or the second feature map, and applying an activation function to the output map.

Clause 7: The computing system of any of clauses 1-6, wherein the attention mechanism comprises computing an equation F_{O}=F_{L} ⊗(1+A_{M}), wherein F_{O} is the output map, F_{L} is the one or more of the first feature map or the second feature map, A_{M} is the attention map, and ⊗ denotes an element-wise multiplication function.

Clause 8: The computing system of any of clauses 1-7, wherein the input image comprises an image of at least a portion of an aircraft or an aircraft component, and wherein the classification output comprises a determination of at least one of an identification of or a state of the aircraft or the aircraft component.

Clause 9: The computing system of any of clauses 1-8, wherein at least one of the first neural network or the second neural network is implemented by an artificial intelligence (AI) accelerator.

Clause 10: A method comprising generating, via a feature extraction network, based on an input image, one or more of a first feature map or a second feature map, generating, via a feature importance network, a feature importance vector based on combining the input image and the first feature map, generating an attention map based on a weighted sum of the feature importance vector and the first feature map, determining a classification output based on combining the attention map and one or more of the first feature map or the second feature map, and generating a feature visualization image by overlaying the attention map onto the input image.

Clause 11: The method of clause 10, wherein the feature extraction network comprises a first neural network including a plurality of convolution layers, wherein the first feature map is obtained from a last layer of the plurality of convolution layers, and wherein the feature importance network comprises a second neural network.

Clause 12: The method of clause 10 or 11, wherein the second feature map is obtained from an intermediate layer, other than the last layer, of the plurality of convolution layers.

Clause 13: The method of clause 10, 11 or 12, wherein combining the input image and the first feature map comprises generating an intermediate image by applying one or more of a downsize function or a greyscale function to the input image, generating an intermediate feature map by applying a normalize function to the first feature map, and generating a masked image by multiplying, via element-wise multiplication, the intermediate image and the intermediate feature map.

Clause 14: The method of any of clauses 10-13, wherein generating an attention map based on a weighted sum of the feature importance vector and the first feature map comprises computing a specific weighted sum Σₖ₌₁^{N}wₖF_{M}^{k}, wherein weights wₖ are derived from respective coefficients of the feature importance vector, and F_{M}^{k} is a k-th channel of the first feature map, and applying an activation function to a result of the specific weighted sum.

Clause 15: The method of any of clauses 10-14, wherein combining the attention map and one or more of the first feature map or the second feature map comprises generating an output map by combining, via an attention mechanism, the attention map and one or more of the first feature map or the second feature map, and applying an activation function to the output map.

Clause 16: The method of any of clauses 10-15, wherein the attention mechanism comprises computing an equation F_{O}=F_{L} ⊗(1+A_{M}), wherein F_{O} is the output map, F_{L} is the one or more of the first feature map or the second feature map, A_{M} is the attention map, and ⊗ denotes an element-wise multiplication function.

Clause 17: The method of any of clauses 10-16, wherein the input image comprises an image of at least a portion of an aircraft or an aircraft component, and wherein the classification output comprises a determination of at least one of an identification of or a state of the aircraft or the aircraft component.

Clause 18: At least one non-transitory computer readable medium comprising instructions which, when executed by a computing system, cause the computing system to perform operations comprising generating, via a feature extraction network, based on an input image, one or more of a first feature map or a second feature map, generating, via a feature importance network, a feature importance vector based on combining the input image and the first feature map, generating an attention map based on a weighted sum of the feature importance vector and the first feature map, determining a classification output based on combining the attention map and one or more of the first feature map or the second feature map, and generating a feature visualization image by overlaying the attention map onto the input image.

Clause 19: The at least one non-transitory computer readable medium of clause 18, wherein the feature extraction network comprises a first neural network including a plurality of convolution layers, wherein the first feature map is obtained from a last layer of the plurality of convolution layers, and wherein the feature importance network comprises a second neural network.

Clause 20: The at least one non-transitory computer readable medium of clause 18 or 19, wherein the second feature map is obtained from an intermediate layer, other than the last layer, of the plurality of convolution layers.

Clause 21: The at least one non-transitory computer readable medium of clause 18, 19 or 20, wherein combining the input image and the first feature map comprises generating an intermediate image by applying one or more of a downsize function or a greyscale function to the input image, generating an intermediate feature map by applying a normalize function to the first feature map, and generating a masked image by multiplying, via element-wise multiplication, the intermediate image and the intermediate feature map.

Clause 22: The at least one non-transitory computer readable medium of any of clauses 18-21, wherein generating an attention map based on a weighted sum of the feature importance vector and the first feature map comprises computing a specific weighted sum Σₖ₌₁^{N} wₖF_{M}^{k}, wherein weights wₖ are derived from respective coefficients of the feature importance vector, and F_{M}^{k} is a k-th channel of the first feature map, and applying an activation function to a result of the specific weighted sum.

Clause 23: The at least one non-transitory computer readable medium of any of clauses 18-22, wherein combining the attention map and one or more of the first feature map or the second feature map comprises generating an output map by combining, via an attention mechanism, the attention map and one or more of the first feature map or the second feature map, and applying an activation function to the output map.

Clause 24: The at least one non-transitory computer readable medium of any of clauses 18-23, wherein the attention mechanism comprises computing an equation F_{O}=F_{L} ⊗(1+A_{M}), wherein F_{O} is the output map, F_{L} is the one or more of the first feature map or the second feature map, A_{M} is the attention map, and ⊗ denotes an element-wise multiplication function.

Clause 25: The at least one non-transitory computer readable medium of any of clauses 18-24, wherein the input image comprises an image of at least a portion of an aircraft or an aircraft component, and wherein the classification output comprises a determination of at least one of an identification of or a state of the aircraft or the aircraft component.

Clause 26: The computing system of any of clauses 1-4, wherein generating an attention map based on a weighted sum of the feature importance vector and the first feature map comprises computing a specific weighted sum Σₖ₌₁^{N} wₖF_{M}^{k}, wherein weights wₖ are derived from respective coefficients of the feature importance vector, and F_{M}^{k} is a k-th channel of the first feature map; and applying an activation function to a result of the specific weighted sum; and wherein the attention mechanism comprises computing an equation F_{O}=F_{L} ⊗(1+A_{M}), wherein F_{O} is the output map, F_{L} is the one or more of the first feature map or the second feature map, A_{M} is the attention map, and ⊗ denotes an element-wise multiplication function.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD (solid state drive)/NAND controller ASICs, and the like. In addition, in some of the drawings, signal conductor lines are represented with lines. Some can be different, to indicate more constituent signal paths, have a number label, to indicate a number of constituent signal paths, and/or have arrows at one or more ends, to indicate primary information flow direction. This, however, should not be construed in a limiting manner. Rather, such added detail can be used in connection with one or more exemplary embodiments to facilitate easier understanding of a circuit. Any represented signal lines, whether or not having additional information, can actually comprise one or more signals that can travel in multiple directions and can be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform or computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and applies to electrical, mechanical, fluid, optical, electromagnetic, electromechanical or other connections, including logical connections via intermediate components (e.g., device A can be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” can mean any combination of the listed terms. For example, the phrases “one or more of A, B or C” can mean A; B; C; A and B; A and C; B and C; or A, B and C.

Those skilled in the art will appreciate from the foregoing description that the broad techniques of the embodiments described herein can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computing system comprising:
a processor; and
a memory coupled to the processor, the memory storing instructions which, when executed by the processor, cause the computing system to perform operations comprising:
generating, via a feature extraction network, based on an input image, one or more of a first feature map or a second feature map;
generating, via a feature importance network, a feature importance vector based on combining the input image and the first feature map;
generating an attention map based on a weighted sum of the feature importance vector and the first feature map;
determining a classification output based on combining the attention map and one or more of the first feature map or the second feature map; and
generating a feature visualization image by overlaying the attention map onto the input image.

2. The computing system of claim 1, wherein the feature extraction network comprises a first neural network including a plurality of convolution layers, wherein the first feature map is obtained from a last layer of the plurality of convolution layers, and wherein the feature importance network comprises a second neural network.

3. The computing system of claim 2, wherein the second feature map is obtained from an intermediate layer, other than the last layer, of the plurality of convolution layers.

4. The computing system of claim 2, wherein combining the input image and the first feature map comprises:
generating an intermediate image by applying one or more of a downsize function or a greyscale function to the input image;
generating an intermediate feature map by applying a normalize function to the first feature map; and
generating a masked image by multiplying, via element-wise multiplication, the intermediate image and the intermediate feature map.

5. The computing system of claim 3, wherein combining the attention map and one or more of the first feature map or the second feature map comprises:
generating an output map by combining, via an attention mechanism, the attention map and one or more of the first feature map or the second feature map; and
applying an activation function to the output map.

6. The computing system of claim 5, wherein generating an attention map based on a weighted sum of the feature importance vector and the first feature map comprises:
computing a specific weighted sum Σₖ₌₁^{N}wₖF_{M}^{k}, wherein weights wₖ are derived from respective coefficients of the feature importance vector, and F_{M}^{k} is a k-th channel of the first feature map; and
applying an activation function to a result of the specific weighted sum; and
wherein the attention mechanism comprises an equation F_{O}=F_{L} ⊗(1+A_{M}), wherein F_{O} is the output map, F_{L} is the one or more of the first feature map or the second feature map, A_{M} is the attention map, and ⊗ denotes an element-wise multiplication function.

7. The computing system of claim 2, wherein the input image comprises an image of at least a portion of an aircraft or an aircraft component, and wherein the classification output comprises a determination of at least one of an identification of or a state of the aircraft or the aircraft component.

8. The computing system of claim 2, wherein at least one of the first neural network or the second neural network is implemented by an artificial intelligence (AI) accelerator.

9. A method comprising:
generating, via a feature extraction network, based on an input image, one or more of a first feature map or a second feature map;
generating, via a feature importance network, a feature importance vector based on combining the input image and the first feature map;
generating an attention map based on a weighted sum of the feature importance vector and the first feature map;
determining a classification output based on combining the attention map and one or more of the first feature map or the second feature map; and
generating a feature visualization image by overlaying the attention map onto the input image.

10. The method of claim 9, wherein the feature extraction network comprises a first neural network including a plurality of convolution layers, wherein the first feature map is obtained from a last layer of the plurality of convolution layers, and wherein the feature importance network comprises a second neural network.

11. The method of claim 10, wherein the second feature map is obtained from an intermediate layer, other than the last layer, of the plurality of convolution layers.

12. The method of claim 10, wherein combining the input image and the first feature map comprises:
generating an intermediate image by applying one or more of a downsize function or a greyscale function to the input image;
generating an intermediate feature map by applying a normalize function to the first feature map; and
generating a masked image by multiplying, via element-wise multiplication, the intermediate image and the intermediate feature map.

13. The method of claim 11, wherein combining the attention map and one or more of the first feature map or the second feature map comprises:
generating an output map by combining, via an attention mechanism, the attention map and one or more of the first feature map or the second feature map; and
applying an activation function to the output map.

14. The method of claim 10, wherein the input image comprises an image of at least a portion of an aircraft or an aircraft component, and wherein the classification output comprises a determination of at least one of an identification of or a state of the aircraft or the aircraft component.

15. At least one non-transitory computer readable medium comprising instructions which, when executed by a computing system, cause the computing system to perform operations comprising:
generating, via a feature extraction network, based on an input image, one or more of a first feature map or a second feature map;
generating, via a feature importance network, a feature importance vector based on combining the input image and the first feature map;
generating an attention map based on a weighted sum of the feature importance vector and the first feature map;
determining a classification output based on combining the attention map and one or more of the first feature map or the second feature map; and
generating a feature visualization image by overlaying the attention map onto the input image.

16. The at least one non-transitory computer readable medium of claim 15, wherein the feature extraction network comprises a first neural network including a plurality of convolution layers, wherein the first feature map is obtained from a last layer of the plurality of convolution layers, and wherein the feature importance network comprises a second neural network.

17. The at least one non-transitory computer readable medium of claim 16, wherein the second feature map is obtained from an intermediate layer, other than the last layer, of the plurality of convolution layers.

18. The at least one non-transitory computer readable medium of claim 16, wherein combining the input image and the first feature map comprises:
generating an intermediate image by applying one or more of a downsize function or a greyscale function to the input image;
generating an intermediate feature map by applying a normalize function to the first feature map; and
generating a masked image by multiplying, via element-wise multiplication, the intermediate image and the intermediate feature map.

19. The at least one non-transitory computer readable medium of claim 17, wherein combining the attention map and one or more of the first feature map or the second feature map comprises:
generating an output map by combining, via an attention mechanism, the attention map and one or more of the first feature map or the second feature map; and
applying an activation function to the output map.

20. The at least one non-transitory computer readable medium of claim 16, wherein the input image comprises an image of at least a portion of an aircraft or an aircraft component, and wherein the classification output comprises a determination of at least one of an identification of or a state of the aircraft or the aircraft component.
